(19) United States
(12) Patent Application Publication
(10) Pub. No.: US 2009/0240928 A1
(43) Pub. Date: Sep. 24, 2009

(54) CHANGE IN INSTRUCTION BEHAVIOR WITHIN CODE BLOCK BASED ON PROGRAM ACTION EXTERNAL THERETO

(75) Inventors: Michael A. Fischer, San Antonio, TX (US); Wesley D. Hardell, San Antonio, TX (US)

Correspondence Address: ZAGORIN O'BRIEN GRAHAM LLP (115), 7600B N. CAPITAL OF TEXAS HWY., SUITE 350, AUSTIN, TX, 78731-1191, US

(73) Assignee: FREESCALE SEMICONDUCTOR, INC., Austin, TX (US)

(21) Appl. No.: 12/050,622

(22) Filed: Mar. 18, 2008

(51) Int. Cl. G06F 9/30

(52) U.S. Cl. 712/226; 712/E09.016

(57) ABSTRACT

Extended, alternate and/or modified instruction behavior can be established using a program construct that appears outside a bounded block of program code in such a way that the behavioral changes are limited to the bounded block and coincide with a particular point in the execution thereof. These extensions, alternations and/or modifications are supported in some processor embodiments in ways that add neither additional code space nor additional execution cycles to the bounded block. In general, the particular point in execution of the bounded block may be specified in a variety of ways, including positionally or temporally. Techniques described herein have broad applicability, but will be understood by persons of ordinary skill in the art in the context of certain illustrative code blocks, including zero- (or low-) overhead loops, lightweight procedures and very long instruction word (VLIW) type instruction packets, and processors that support them.

### BACKGROUND

1. Field

This disclosure relates generally to data processing systems, and more specifically, to techniques for managing extended, alternate and/or modified instruction behavior in a code block executed in a data processing system.

2. Related Art

Processor designs have long sought to provide mechanisms for varying the execution behavior of instructions. For example, many generations of processors have supported varying execution modes whereby each instance of a given instruction executes in accordance with a then-operative execution mode. Rounding, saturation and precision modes for arithmetic instructions are both good examples of such variation.

In some cases, augmented instruction encodings have been employed to specify certain extended behaviors for particular instances of an instruction by using additional coding width to specify the extended behaviors. For example, some processor designs allow specification of additional register targets or immediate values based on augmented (additional-width) instruction codings supported for those instruction instances that appear within a loop. In other cases, conditional or predicated execution of a subsequent instruction has been provided based on a processor status condition that results after execution of a prior instruction. For example, some processor designs support conditional or predicated execution of branch instructions based on carry, overflow or other status resulting after execution, in a preceding cycle, of a prior instruction.

In some processors, e.g., in some embedded processor implementations, specialized mechanisms are provided to facilitate efficient execution of certain loops. For example, zero- (or low-) overhead loop mechanisms can allow compact loops, typically 4, 8 or some other small and fixed number of instructions, to execute without the overheads normally associated with generalized loop constructs. Typically, zero-overhead loop mechanisms seek to eliminate from the loop body the one or more instructions that would otherwise manipulate a loop index, test a loop predicate and provide a backward branch. In some processors, zero-overhead loop mechanisms seek to maximize computational performance by ensuring that instructions of the loop may be iteratively executed directly from a buffer without additional instruction fetch overheads.

For some computations and in processor implementations, instructions that make up a loop body or other instruction sequence may not fit neatly within the limited extent of a zero-overhead loop or other strictly-bounded code block construct supported by the processor. Accordingly, new techniques are desired for allowing programmers to better exploit the limited extent of such strictly-bounded code blocks. In addition, new techniques are desired for varying execution behavior of individual instruction instances without exacerbating constraints imposed by a strictly-bounded code block.

### BRIEF DESCRIPTION OF THE DRAWINGS

The present invention may be better understood, and its numerous objects, features, and advantages made apparent to those skilled in the art by referencing the accompanying drawings.

FIGS. 1 and 2 are respective block diagrams of a general purpose and embedded-type data processing systems in accordance with some embodiments of the present invention.

FIG. 3 is a block diagram that illustrates functional units of a switch on event multithreading (SOEMT) type embedded processor-based system in which techniques in accord with the present invention may be practiced and illustrated.

FIG. 4 is an illustration of context activation and transitions in an SOEMT type processor.

FIG. 5 is an illustration of relations between a zero-overhead loop type bounded block of program code and a program construct used to establish respective a behavioral extension therewithin.

FIG. 6 is an illustration of zero-overhead loop operation based on extended behavior established in an SOEMT type processor in accordance with certain illustrative techniques of the present invention.

FIG. 7 is a flow diagram illustrating a method, in accordance with some embodiments of the present invention, in which modified behavior is established for a particular instruction instance or execution within a strictly bounded code block.

FIGS. 8 and 9 are illustrations of relations between respective instances of bounded blocks of program code and program constructs used to establish respective behavioral extensions therewithin. FIG. 8 illustrates a general embodiment in accordance with the present invention and consistent with a variety of bounded blocks of program code. FIG. 9 illustrates a very long instruction word (VLIW) type instruction packet embodiment in accordance with the present invention.

### DETAILED DESCRIPTION

Mechanisms that facilitate selective variation in the execution behavior of particular instructions within a code block can be used by programmers to pack greater functionality into the limited extent of a zero-overhead loop or other strictly-bounded code block construct supported by a processor. Unfortunately, conventional techniques for varying execution behavior which tend to increase the coding width of individual instructions or which tend to introduce additional instructions within the strictly-bounded code block tend to exacerbate limitations of the construct(s). Additional and/or alternative techniques are desired.

It has been discovered that extended, alternate and/or modified instruction behavior can be established using a program construct that appears outside a bounded block of program code in such a way that the behavioral changes are limited to the bounded block and coincide with a particular point in the execution thereof. These extensions, alternations and/or modifications are supported in some processor embodiments in ways that add neither additional code space nor additional execution cycles to the bounded block. In general, the particular point in execution of the bounded block may be specified in a variety of ways, including positionally or temporally. Techniques described herein have broad applicability, but will be understood by persons of ordinary skill in the art in the context of certain illustrative code blocks, including zero- (or low-) overhead loops, lightweight procedures and very long instruction word (VLIW) type instruction packets, and processors that support them.

For concreteness, we focus on extensions to the ordinary behavior of a processor at a given point in the execution of a strictly bounded code block. For example, in some embodiments, a wait function not coded within a zero-overhead loop itself is established as an extended behavior for a particular instruction instance or execution cycle of the zero-overhead loop executed on a switch on event multithreading (SOEMT) processor. Because the extended behavior need not be coded within the loop, e.g., using a conventional and explicit wait instruction, the wait functionality can be provided without use one of the limited number of instruction positions. Techniques described herein have broad applicability to other strictly bounded code blocks and in other processor designs, but will be understood and appreciated by persons of ordinary skill in the art in the illustrated context of wait-type behavioral extensions and the utility of such extensions for support of a zero-overhead loop construct on an SOEMT processor.

Accordingly, in view of the foregoing and without limitation on the range of underlying processor or system architectures; bounded block or other software constructs; and extended functionalities that may be employed in embodiments of the present invention, we describe certain illustrative embodiments.

### Systems and Integrated Circuit Realizations, Generally

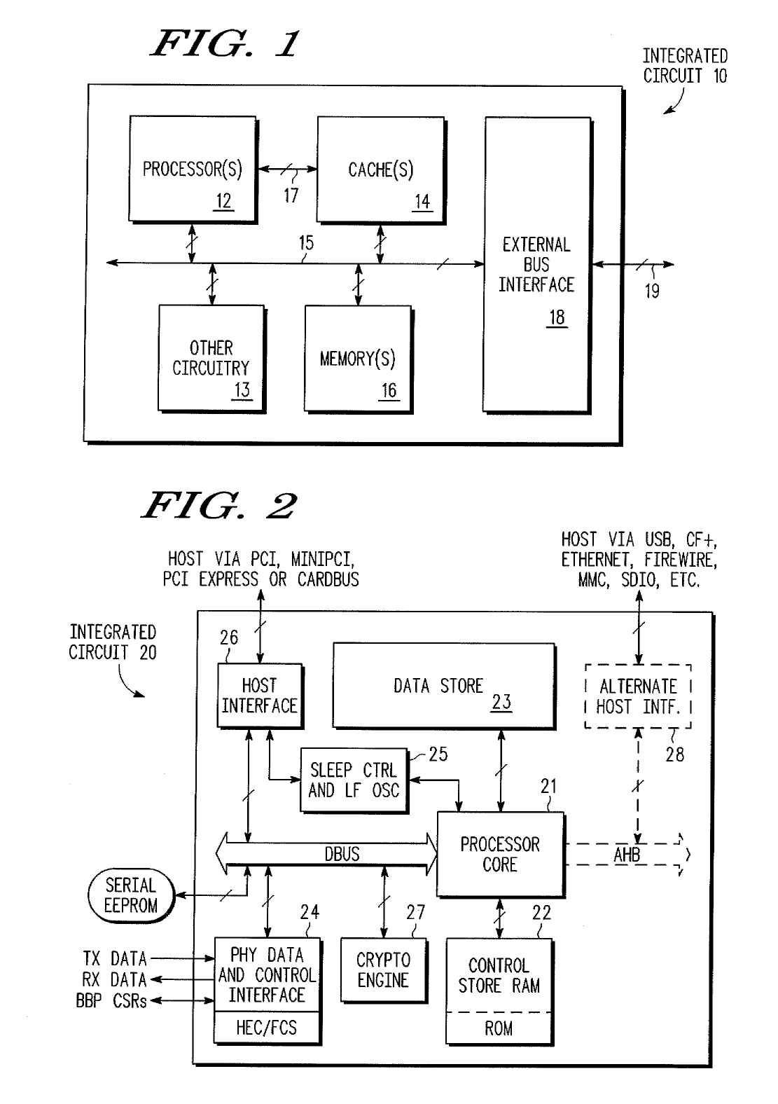

FIGS. 1 and 2 are respective block diagrams of a general purpose data processing system and a somewhat more specialized, embedded processor-type data processing system, each in accord with some embodiments of the present invention. FIG. 1 shows an information processing configuration that includes processor(s) 12, cache(s) 14, memory(s) 16, an external bus interface 18 and other circuitry 13. In the illustrated configuration, the aforementioned components are together embodied as exemplary integrated circuit 10; however, in other embodiments one or more components may be implemented in separate integrated circuits. Internal components of illustrated integrated circuit 10 are interconnected and interoperate using any suitable techniques. For simplicity, we illustrate interconnection amongst major functional blocks via bus 15, although persons of ordinary skill in the art will recognize that any of a variety of interconnection techniques and topologies may be employed without departing from the present invention. In general, integrated circuit 10 may interface to external components via external bus 19 or using other suitable interfaces.

Processor(s) 12 are of any type in which an extended, alternate and/or modified behavior is supported for executions of instruction instances that reside within a bounded block of code. Typically, implementations of processor(s) 12 include a fetch buffer or other facility for storing instructions to be executed by the processor(s), decoder and sequencing logic, one or more execution units, and register storage, together with suitable data, instruction and control paths. At any given time, consistent with a computation performed by processor(s) 12, units of program code (e.g., instructions) and data reside in memory(s) 16, cache(s) 14 and/or processor stores (such as the fetch buffer, registers, etc.) In general, any of a variety of hierarchies may be employed, including designs that separate or commingle instructions and data in memory or cache. In addition, although FIG. 1 shows separate memory(s) 16 and cache(s) 14, other realizations consistent with the present invention may include one, but not the other, or may combine two or more levels of a memory hierarchy into one element or block. Processor facilities, e.g., logic, suitable for selectively providing behavioral extensions are described below.

FIG. 2 shows an embedded processor-type information processing configuration that includes a processor core 21, together with a control store 22, a data store 23 and various illustrative data and control flow paths. As before, support for extended, alternate and/or modified behavior by an instruction instance that resides within a bounded block of code is typically provided within processor circuits (here, processor core 21) and is described in greater detail below. Also as before, the components are illustrated together as exemplary integrated circuit 20; however, in other embodiments, one or more components may be implemented in separate integrated circuits. In contrast with the illustration of FIG. 1, FIG. 2 illustrates architectural features more commonly associated with some real-time, embedded-type architectures. Note that the features and architecture illustrated in FIG. 2 are not essential to any particular realization of the inventive techniques. Nonetheless, FIG. 2 and, in general, architectural features of typical real-time, embedded-type processor designs do provide a useful context in which to describe our techniques.

Internal components of illustrated integrated circuit 20 are interconnected and interoperate using any suitable techniques. For simplicity, we illustrate interconnection amongst major functional blocks via a bus DBUS and separate dedicated pathways (e.g., busses) for transfer of data to/from a local data store 23 and for fetching instructions from a local control store 22. That said, persons of ordinary skill in the art will recognize that any of a variety of interconnection techniques and topologies may be employed. In general, integrated circuit 20 may interface with external components (e.g., a host processor or system), transmit/receive circuits, event sources, input output devices, etc., via external buses or using other suitable interfaces.

In the illustration of FIG. 2, an embedded processor-type data processing system is configured for use as media access controller suitable for use in a wireless (e.g., 802.11n) station adapter. Of course, techniques of the present invention are not limited thereto. In the illustrated configuration, an interface 24 (PHY data and control) to transmit and receive circuits is provided together with a dedicated cryptographic engine 27 (or processor), timing/oscillator circuits 25 and interface(s) 26, 28 to one or more hosts. Typically, implementations of processor core 21 include a fetch buffer or other facility for storing instructions to be executed by one or more execution units of the core, decoder and sequence control logic, timer and event handling logic, and register storage, together with suitable data, instruction and control paths.

At any given time, consistent with a computation performed, units of program code (e.g., instructions) reside in control store 22 and units of data reside in data store 23 and/or in stores provided within processor core 21 (such as context-specific fetch buffers, registers, etc.) In general, configuration of FIG. 2 maintains a “Harvard-architecture” style separation of instructions and data, although other approaches and other storage hierarchies may be employed, if desired. Processor facilities, e.g., logic, suitable for selectively providing behavioral extensions are described below.

Consistent with a wireless MAC protocol controller application, the embedded-type data processing system illustrated in FIG. 2 includes features selected for efficient implementation of event-driven, real-time code for applications. Although techniques of the present invention may be exploited in any of a variety processor designs or architectures (embedded-type or otherwise) and, based on the description herein, persons of ordinary skill in the art will appreciate the richness of design variations, certain aspects of an illustrative embedded processor instance are described for concreteness.

### Switch On Event Multi-Threading (SOEMT), as an Example

Design choices made in at least some processor and integrated circuit implementations may deemphasize or eliminate the use of priority interrupts more commonly employed in conventional general purpose processor designs and instead, treat real-time (exogenous and endogenous) conditions as events. For example, in some implementations, assertion of an (enabled) event activates a corresponding one of multiple execution contexts, where each such context has (or can be viewed as having) its own program counter, fetch buffer and a set of programmer-visible registers. Contexts then compete for execution cycles using prioritized, preemptive multithreading, sometimes called “Switch-On-Event MultiThreading” (SOEMT). In some implementations, context switching occurs under hardware control with zero overhead cycles.

Generally, an instruction that has been issued will complete its execution, even if a context switch occurs while that instruction is still in the execution pipeline. In an illustrative SOEMT processor implementation, once a context is activated, the activated code runs to completion (subject to delays due to preemption by higher-priority contexts). If another of the context's events is asserted while the context is active to handle a previous event, handling of the second event occurs immediately after the running event handler terminates. Typically, deactivation of one context and initiation (or resumption) of the next context occurs based on execution of a wait instruction.

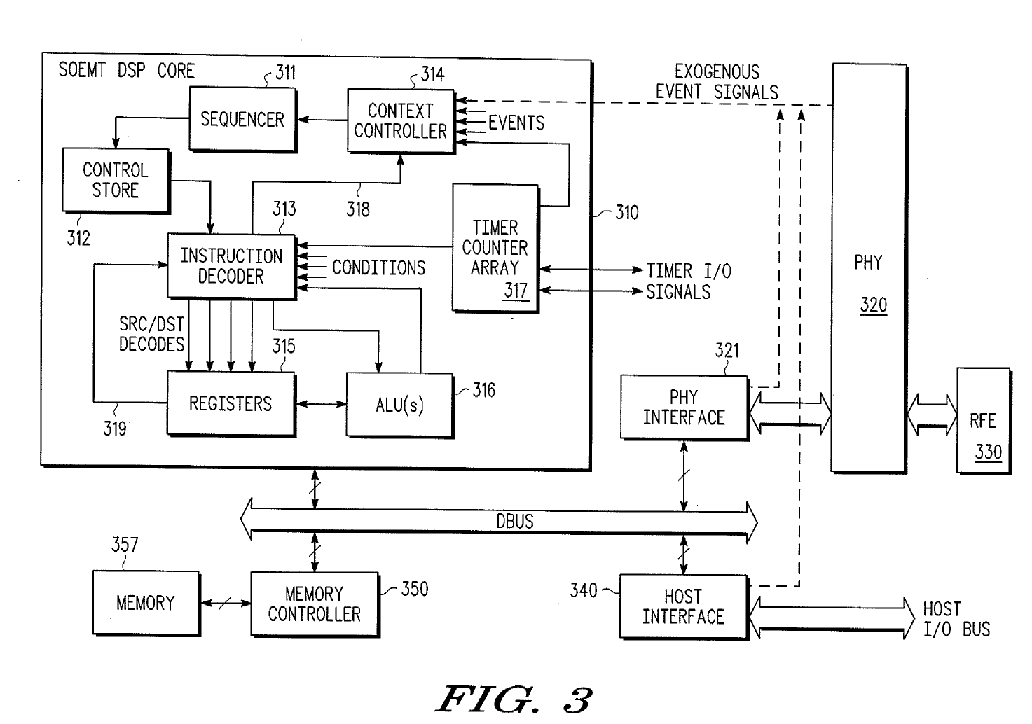

FIG. 3 is a block diagram that illustrates functional units of a switch on event multithreading (SOEMT) type embedded processor-based system in which techniques in accord with the present invention may be practiced and illustrated. In particular, FIG. 3 illustrates an SOEMT core 310 that includes one or more arithmetic logic units, ALU(s) 316, that execute(s) instructions fetched from control store 312 and decoded by instruction decoder 313. In the illustration, instruction decoder 313 is selective for source and/or destination register targets (in registers 315) of instructions decoded by instruction decoder 313. Although not explicitly shown, registers 315 may include register sets separately maintained for each context executed by core 310 as well as registers whose state is shared amongst two or more contexts. As illustrated by flow 319, register state may, in some cases, affect operation of instruction decoder 313. For example, in some implementations consistent with FIG. 3, two context registers defined or definable within registers 315 and described in greater detail below, repeat count (RC) and wait offset (WTOFS), may be employed in implementations of certain zero-overhead loops and of behavioral extensions that establish wait functionality coincident with a particular instruction or execution cycle of such a loop.

FIG. 3 includes a sequencer 311 and a context controller 314 that, responsive to activation events, preempts one or more executing context(s) in accord with a prioritization of contexts and mapping of activation events thereto. As illustrated, activation events may be exogenous, such as events supplied via a physical layer data and control interface (PHY) 320 based on radio front end (RFE) 330 activity, I/O events or signals, or may be generated internally within the core itself, e.g., as a result of the computations performed by one or more contexts executed on core 310. Furthermore, as illustrated by flow 318, context controller 314 may be responsive to instruction decoder 313 such as in the case of an explicitly coded wait instruction or in accord with behavioral extensions that establish wait functionality as described in greater detail herein. Configurations and interconnection of memory controller 350, memory 357, host interface 340 and PHY 321 with SOEMT core 310 via the illustrated bus DBUS are purely illustrative.

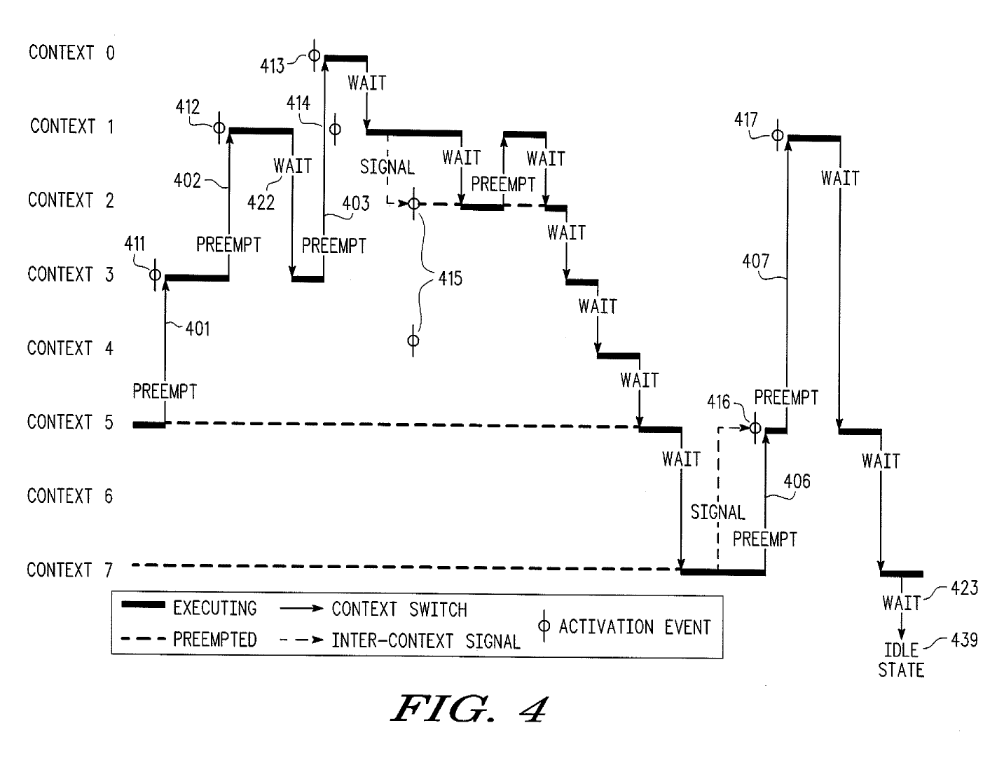

FIG. 4 illustrates a sequence of context activations and transitions in an SOEMT-type processor. As previously emphasized, embodiments of the present invention are not limited any particular processor design, including SOEMT-type designs. However, since explicit use of wait instructions is common in SOEMT-type designs and since some exploitations of our techniques encode a wait as a behavioral extension operant at a positionally or temporally specified point within a bounded block of code, a basic description of wait instruction triggered transitions in an SOEMT-type processor may be helpful.

A basic concept of SOEMT-type designs is that the processor should spend its time executing instructions on behalf of a highest priority thread (or in concurrent or fine grained multithreading variants, on behalf of a highest priority set of threads) that is (are) ready to execute. Because it can be impractical to have dedicated state stored in hardware for each of an arbitrary number of threads, a given SOEMT-type implementation may compromise by providing separate register sets, and hardware-based, prioritized selection, for a small, finite number of execution threads, each of which is referred to as a context. FIG. 4 illustrates eight contexts, but other implementations may provide dedicated resources to support larger or smaller numbers of contexts. In any case, during each instruction cycle, a functional unit such as a context controller compares priorities assigned to each active (ready to run) context to determine the context number of the active context with the highest-priority. If the highest-priority context is not the executing context, the context controller initiates a context switch at the end of the current instruction cycle to preempt (see preemption 401) execution by the lower-priority context.

Although the illustration of FIG. 4 presumes a single executing context, persons of ordinary skill in the art will appreciate that concurrent multithreading techniques and/or fine-grained interleaving techniques may also be employed. Accordingly, while this description focuses (at times) on preemption of a single context by a single higher priority context or on resumption of a single, next-highest priority context after completion of execution for an active context, persons of ordinary skill in the art will recognize that, in some implementations, multiple contexts (from a set of active contexts) may be executing at any given time. It is therefore for reasons of simplicity and clarity of description, and without limitation, that we focus on preemption and resumption of individual contexts.

Often, a context switch involves a small number of instruction cycles (sometimes called the activation delay) for retrieving an initial instruction address for a preempting context and accessing the instruction at that address. For example, in an implementation with a 2-cycle activation delay, if the initial instruction is available in the fetch buffer, the preempting context can execute its first instruction on the third cycle after the context switch was initiated, which may be as soon as the fourth cycle after the activation event that led to the context switch. If the initial instruction is not available in the fetch buffer and must instead be fetched from a control store, the context switching latency may be increased.

In the illustration of FIG. 4, each context (e.g., contexts 0, 1, . . . 7) is potentially responsive to a corresponding set of one or more activation events, which are illustrated as events. For example, context 1 (e.g., a Media Access Control layer receive context, MAC RX) may be responsive to activation events 412 and 414 that indicate presence in a buffer of incoming data to be processed. In general, assertion of an event sets the active bit for one or more contexts, indicating that the corresponding context (or contexts) is (are) ready to run. If a corresponding context is of higher priority than that currently executing, the higher priority context preempts (see e.g., activation event 412 and corresponding preemption 402); however, if a still higher priority context is currently executing (see e.g., activation event 414), the corresponding context may await completion of the higher priority context. In general, activation events can include external events, such as events generated by a physical layer interface (e.g., PHY data and control interface 24, see FIG. 2) based on inbound or outbound communications, events generated by host interface 26, internal events generated by hardware entities within the core (e.g., events based on counter/timers), firmware-generated events and even events based on inter-context signaling.

After activation, a context executes to completion. While active, a context generally has full control of the processor, except during cycles when its execution is suspended or when the context is preempted by a higher-priority context. For example, in the illustration of FIG. 4, context 1, which preempted (402) context 3, remains active until it completes its handling of activation event 412. Execution of a wait instruction (e.g., wait 422) indicates completion. Thereafter, execution of a lower priority context (context 3) resumes. When the executing context performs its wait, a context controller (e.g., context controller 314, FIG. 3) initiates a context switch to the active context with the next-highest priority. This context switch typically involves a small number of instruction cycles. For example, in some implementations, two additional instructions are executed after a running context executes its wait instruction and before the running context becomes inactive. This two-cycle period is known as the wait delay. If there are no active contexts when the executing context performs its wait, the processor enters an idle state (see e.g., idle state 439 after wait 423). While idle, no instructions are executed, and data paths of the SOEMT-type processor do not need to be clocked, but the context controller, and event-generating units such as the timers, continue to operate, pending occurrence of an activation event for any context. If an activation event is asserted for a context that is already active (whether executing, preempted, or suspended) the context is not interrupted. However, when the context executes its next wait instruction, no context switch need occur and execution by that context continues pursuant to the next activation event.

As will be apparent from the preceding discussion, SOEMT-type processor designs can be well adapted for efficient implementations of event-driven code for applications such as in controllers for complex network protocols or communications with significant real-time requirements. In such applications, efficient zero-overhead context switches (e.g., at both activation/preemption and wait/resumption) can provide significant performance advantages, particularly when compared with conventional heavy-weight task, process or thread scheduling techniques and pursuant to events signaled using priority interrupts. Of course, these advantages are, in some ways, premised on the ability of a programmer to code instructions of a relevant code block compactly enough to allow a next-to-be-executed instruction of a preempting or resuming context to be executed without storage access delays. For example, in some processor implementations, zero-overhead context switches may be assured only if the next-to-be-executed instruction resides in a fetch buffer of the preempting or resuming context. Note that a processor that uses an instruction cache may well derive a similar benefit with regard to a next-to-be-executed instruction residing in-cache.

### Bounded Blocks of Program Code

Processor designs often provide programming and/or architectural constructs that afford a strictly bounded code block certain execution performance advantages over arbitrary sequences of instructions. One such construct is the zero-overhead loop. For example, in some embedded processor implementations, including some SOEMT-type designs, a specialized mechanism can be provided to facilitate efficient (e.g., zero-overhead or low-overhead) execution of certain compact loops, typically 4, 8 or some other small and fixed number of instructions. Typically, zero-overhead loop mechanisms seek to eliminate from the loop body one or more instructions that would otherwise manipulate a loop index, test a loop predicate and provide a backward branch. Furthermore, some implementations of zero-overhead loop mechanisms can maximize computational performance by ensuring that instructions of the loop may be iteratively executed directly from a buffer without additional instruction fetch overheads.

To illustrate, and again without limitation, we summarize operation of two example zero-overhead loop instructions. These zero-overhead loop instructions, rept4 and rept8, are merely examples and are not essential to any particular processor or computer program product embodiment of the present invention. Rather they provide a useful and concrete framework for understanding one type of bounded block and for explaining certain techniques for establishing behavioral extensions in accord with some embodiments.

In a processor that implements a rept4 or a rept8 instruction, zero-overhead loops may be coded as follows: a rept4 instruction starts a zero-overhead loop that repeats the instructions whose first byte is contained within the four bytes immediately following the rept4 instruction until a value in a repeat count register, rc, reaches zero. The body of a rept4 loop may include 1 to 4 instructions, which (in an illustrative implementation) can occupy 4 to 7 sequential bytes. At the end of each iteration, the repeat count is tested and decremented if greater than zero (rc>0), so the loop body is executed at least once. In like fashion, a rept8 starts a zero-overhead loop that repeats the instructions whose first byte is contained within the eight bytes immediately following the rept8 instruction. The body of a rept8 loop may include 2 to 8 instructions, which occupy 8 to 11 sequential bytes.

In addition to zero- (or low-) overhead loops, other examples of strictly bounded code blocks include lightweight threads, tasks or procedures and very-long instruction word (VLIW) packets. In each case, the advantages of the construct for an implemented computation tend to depend on the ability of a programmer, compiler and/or hardware to generate a sequence (or set) of instructions compactly enough to fit within the bounds of the construct. For example, a computation that requires five instructions within its loop body simply will not fit within the strictly-bounded code block defined by a rept4 loop. Similarly, the number of processor cycles per iteration in a VLIW processor architecture that provides four (4) operation positions per very-long instruction word may double for a loop body that requires a set of five (5) operations and therefore exceeds the coding space available within a single VLIW instruction packet. Likewise, an instruction sequence that exceeds the limitations of a lightweight thread construct may require use of a conventional heavyweight construct and all the context switch overheads that the heavyweight implementation entails.

Thus, for some computations and in some processor implementations, instructions that make up a loop body or other instruction sequence may not fit neatly within the limited extent of a zero-overhead loop, VLIW instruction packet, lightweight thread or other strictly-bounded code block construct supported by the processor. Accordingly, a challenge can exist (both in the preparation of a computer program products and in the design of logic, circuitry and/or firmware of a processor on which instruction sequences of such computer program products are to execute) to code and support functionality relevant to a particular computation or algorithm in a way that avoids the bounds (or coding space limitations) of a strictly-bounded block of program code. In some cases, saving just one instruction from a loop body or instruction sequence may allow a programmer to exploit the construct. In other cases, use of one construct (e.g., a rept4 loop) rather than another (e.g., a rept8 loop) may afford greater flexibility with respect to memory alignments or provide faster, tighter inner loops or improved response latency such as on resumption (in an SOEMT-type processor) of a previously preempted context.

To illustrate the need in a concrete way, we now describe the following pseudocode for an SOEMT processor that employs a rept8 zero-overhead loop to transfer successive words from a transmit buffer in a data store (e.g., data store 23, FIG. 2, or memory 357, FIG. 3) to a peripheral interface (e.g., PHY data and control interface 24, FIG. 2, or PHY interface 321, FIG. 3).

| 10 <load k with start of buffer address> | |
|---|---|
| 20 <load t with transmit byte count> | |
| 30 <load rc with buffer word count> | |
| 40 rept8 | |
| 41 mrdout | |
| 42 sl4 | |
| 43 wait | ;explicit initiation of wait |
| 44 sub | |
| 45 nop | ;wait occurs here |
| 46 nop | |
| 47 nop | |
| 48 skp | le3 |

49 br end_of_buffer_block
50 <handle end of transmission>

After initializing appropriate registers (at lines 10 and 20) and initializing a repeat count, rc, the rept8 loop reads individual 4-byte words from the transmit buffer (using the mrdout instruction at line 41), correspondingly decrements a transmit byte count, t, by subtracting the quantity four (4) therefrom (see lines 42, 44) and tests a “less than or equal to 3” (le3) predicate (line 48). Finally, bytes remaining in the transmit buffer (t≦3), if any, are handled outside the rept8 loop.

Each iteration of this rept8 loop loads one word into the transmit data holding register of the peripheral interface, after which execution of the loop is paused (due to the wait instruction) until the transmit data holding register is again empty, at which time execution of the loop is resumed (due to an activation event). During this pause, this context is inactive and a next-highest priority active context is able to execute. Thus, five instructions (mrdout, s14, wait, sub, and skp le3) are employed in the loop body, exceeding the limitations of the more compact rept4 loop. No operation instructions (nop instructions at lines 45-47) are used to pad the unused positions of the rept8 loop. The conditional skip instruction (skp le3) is located after these nop instructions because the conditional skip needs to occur at the physical end of the loop.

### Extended Execution Behavior

Based on the preceding pseudocode, it will be apparent that coding techniques that allow the elimination of even one instruction from a bounded block (such as from the body of a zero-overhead loop or other strictly-bounded code block) may allow us to employ a construct that is particularly efficient for an implemented computation or algorithm. For example, in the material that follows, we show how elimination of the explicit wait instruction from the loop body of the preceding pseudocode allows us to employ a rept4 loop, thereby reducing both the number of cycles per iteration and, in an SOEMT-type design, response latency on activation or resumption of another context. Note that elimination of an explicit wait instruction also has benefit, even if a 5-instruction, zero-overhead loop were available, due to elimination of an execution cycle during each iteration of the loop body. Based on the concrete example(s), persons of ordinary skill in the art will also appreciate applications of our techniques to other strictly bounded code blocks (such as to other zero-overhead loops, VLIW packets, lightweight threads, etc.), to other extended behaviors (e.g., to supply of acknowledgements, to trace enableldisable, etc.) and to other processor designs (including those that do not, or need not, employ an SOEMT-type execution model).

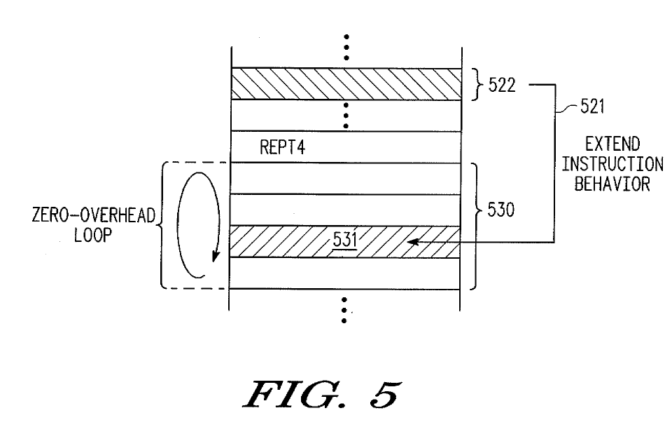

In view of the above, and without limitation, some embodiments in accordance with the present invention provide extended instruction behavior within a zero-overhead loop. FIG. 5 illustrates some embodiments in which one or more instructions 522 executed within a current context, but which appear outside the body of zero-overhead loop 530, are used to establish (521) an extended instruction behavior at a particular point (e.g., instruction 531) in zero-overhead loop 530. In general, such a point may be positionally-specified (such as at a particular instruction offset or absolute address within the loop) or temporally-specified (such as at a particular instruction count or execution cycle after loop entry). Note that, in the case of a temporally-specified point, the extended instruction behavior might be established for a particular execution of instruction 531 (e.g., during a second iteration through, as with a temporally-specified seventh (7^{th}) cycle after loop entry).

Building on the pseudocode introduced above as an example, we illustrate (below) use of positionally-specified extended behavior to establish wait functionality at a particular point in the execution of a zero-overhead loop without explicit coding of a wait instruction within the loop body.

| 10 <load k with start of buffer addr> | |
|---|---|
| 20 <load t with transmit byte count> | |
| 30 <load rc with buffer word count> | |
| 35 sl1 | ;wait offset of 1 |
| 36 >wtofs | ;wait at instruction 1 within loop |
| 40 rept4 | |
| 41 mrdout | |
| 42 sl4 | ;wait initiated here by wtofs setting |

43 sub
44 skp le3 ;wait occurs here
45 br end_of_buffer_block
50 <handle end of transmission>

As before, pseudocode is consistent with an SOEMT processor that employs a zero-overhead loop to transfer successive words from a transmit buffer in a data store (e.g., data store 23, FIG. 2, or memory 357, FIG. 3) to a peripheral interface (e.g., PHY data and control interface 24, FIG. 2, or PHY interface 321, FIG. 3). After initializing appropriate registers (at lines 10 and 20) and initializing a repeat count, rc (lines 30), the zero-overhead loop reads 4-byte words from the transmit buffer (using the mrdout instruction at line 41), correspondingly decrements a transmit byte count, t, by subtracting the quantity four (4) therefrom (see lines 42, 43) and tests a “less than or equal to 3” predicate (line 44). As before, bytes remaining in the transmit buffer (t≦3) are handled outside the loop. However, unlike the previous example, no wait instruction appears within the body of the F loop and, accordingly, we are able to employ a rept4 zero-overhead loop, rather than the suboptimal rept8 loop.

Wait functionality is instead established based on execution of a pair of instructions found outside the zero-overhead loop. In particular, the example pseudocode illustrates use of a wait offset instruction (>wtofs at line 36) that establishes, based on the literal value that precedes it (s11 at line 35 specifies a short literal of 1), an extended behavior (i.e., a wait function) that is initiated at a positional offset of 1 (i.e., at line 42) in the rept4 loop. As with an explicitly coded wait instruction, the extended behavior takes effect two cycles after it is initiated (i.e., at line 44). By eliminating the wait instruction from the loop body, we are able to employ the rept4 zero-overhead loop. As a result, no nop instructions are used to pad unused instruction positions within the loop body and response latency (after the next activation event) to next execution of the mrdout instruction is reduced to zero. The number of cycles to execute each iteration of this loop is reduced from 8 (5 functional, 3 nop) to 4 (all functional) since no cycles within this loop body are used for either wait or nop instructions.

### Operation of an Example SOEMT Processor

For an SOEMT processor implementation that employs the techniques described herein, advantages can be significant. For example, in a network or communications controller implementation, tighter zero-overhead loops and reduced response latencies can allow a higher symbol rate to operating frequency ratio. Accordingly, in some designs, it is possible to achieve a target symbol rate at lower operating frequency and with lower power consumption. Conversely, in some designs, it can be possible to achieve higher symbol rates at a given operating frequency and/or power budget.

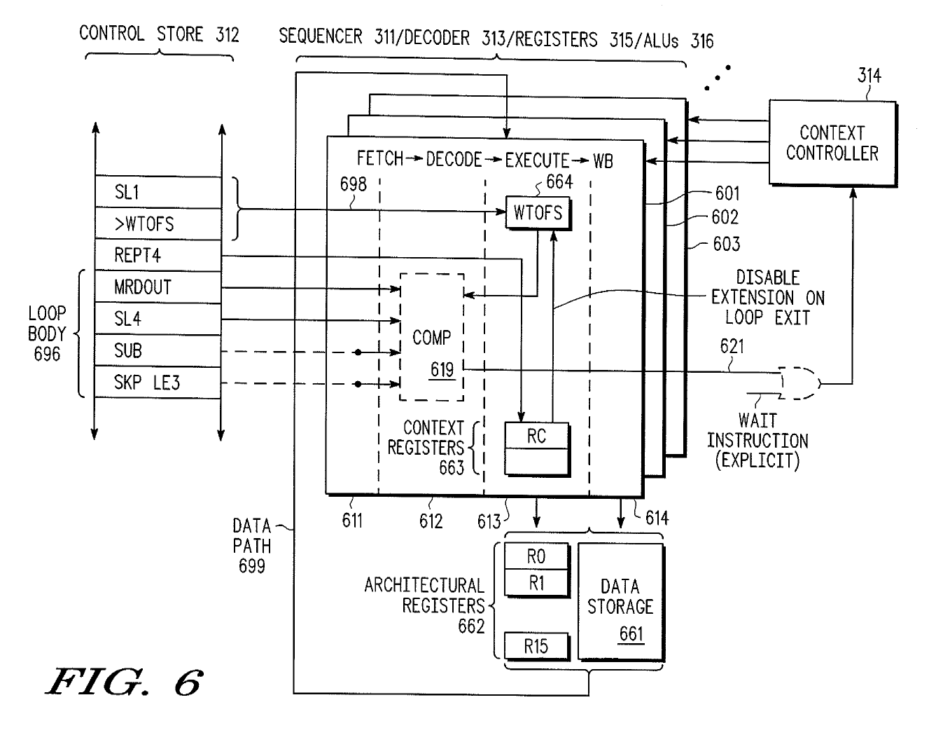

Referring to FIG. 6, we illustrate operation of selected elements of a processor core, e.g., that previously introduced as SOEMT embedded core 310 (recall FIG. 3) and its constituent elements, sequencer 311, decoder 313, registers 315, ALU(s) 316, to support (consistent with an SOEMT execution model) activation, preemption and resumption of a various execution contexts 601, 602, 603, . . . under control of context controller 314. Fetch 611, decode 612, execute 613 and write back 614 stages of a pipeline are illustrated relative to an instruction sequence including a rept4 zero-overhead loop, such as previously described, being executed from control store 312 by the processor core. A data path 699 for the currently executing context 601 includes architectural registers 662 and/or data storage 661 such as memory. Of course, pipeline and data path design are purely illustrative and, based on the description herein, persons of ordinary skill in the art will appreciate adaptations for other designs.

In the illustrated instruction sequence, execution of a wait offset instruction (>wtofs) establishes (698) in context register WTOFS 664, a positional offset into the rept4 loop at which an extended behavior (e.g., a wait function) is to be initiated. In the illustration, the offset is based on the s11 instruction (load immediate value 1) that specifies a literal value of 1, although any of a variety of codings are suitable. During decode of successive instructions appearing in the body 696 of the rept4 loop (e.g., the mrdout, s14, sub and skp le3 instructions illustrated), corresponding program counter or instruction pointer values (typically, baselined as offsets into the rept4 loop) are compared (619) with the positional offset stored in context register WTOFS 664. Thus, upon execution of the s14 instruction, an extended behavior (a wait function) is initiated (621) which causes context controller 314 to deactivate (typically after 2 instruction cycles) this context and resume a next-highest priority active context. In the illustrated configuration, context controller 314 is responsive either a wait function established in accordance with techniques of the present invention or an explicitly coded wait instruction. Upon exit of the rept4 loop (e.g., after a number of iterations corresponding to a value of repeat count stored in register RC), the extended behavior is disabled. In the illustration, context registers 663 (including register RC and register WTOFS 664) are instances local to the current context (context 601). Any of a number of techniques may be employed encode state for the executing context and signify disabling of the extended behavior, including by storing a reserved value in register WTOFS 664.

Although the illustration of FIG. 6 assumes a positionally-specified point in the execution of the rept4 loop, adaptations for a temporally-specified point are straightforward. For example, one simple variation on the operations described above is to establish a cycle count in context register WTOFS 664 and modify comparison 619 to instead compare against an incrementing count of cycles within the current iteration of loop body 696.

While we have focused on currently executing context 601, it should be understood that the other contexts amongst which context controller 314 switches may, and likely will, also include bounded blocks of program code (perhaps in the form of rept4 or rept8 loops). Accordingly, respective instances of our behavior extension techniques may be operant at any given time in two or more of the illustrated contexts. In addition, while the illustration of FIG. 6 presumes a single operant behavioral extension per context whose effect is limited to the illustrated loop body 696, multiple operant behavioral extensions could be established in a given context, if desired. For example, it would be straightforward to add or employ additional context registers to identify additional points in the execution of the illustrated loop body 696 (or other bounded blocks) or to support of other behavioral extensions.

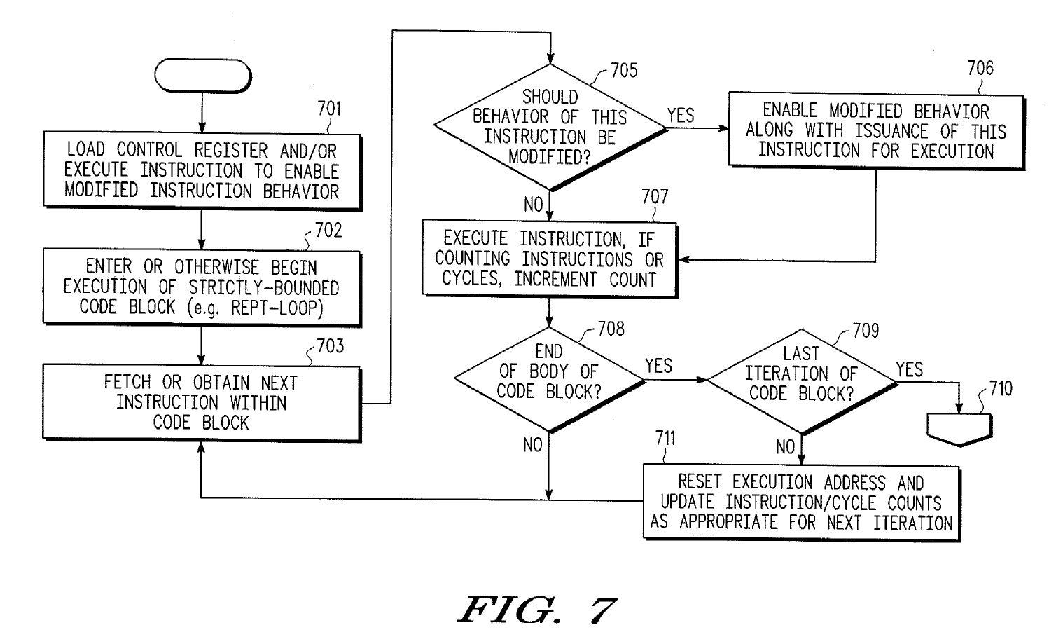

Turning to FIG. 7, a method of operation will be understood in accordance with some embodiments of the present invention. Initially, an extended, alternate and/or modified instruction behavior is enabled (701) based on loading a control register and/or executing an appropriate instruction (or instructions). Enabling is performed outside a strictly-bounded code block such as a zero-overhead loop, VLIW instruction packet, lightweight thread, etc. Thereafter, the strictly-bounded code block is entered or otherwise initiated (702). A next (and later subsequent) instruction(s) of the strictly-bounded code block is (are) fetched (703) or otherwise obtained for execution. A check is made (705) regarding whether behavior of the current instruction is to be extended, altered or modified. If so, the extended, altered or modified behavior is enabled (706), for performance with issuance of the instruction, the instruction is executed (707) and an instruction (or cycle) count is incremented (or otherwise tracked). If not, the instruction is simply executed (707) without any extended, altered or modified behavior and the instruction (or cycle) count is incremented (or otherwise tracked).

If a given instruction execution does not correspond to the end of the strictly-bounded code block (test 708), the next instruction in the code block is fetched (703) or otherwise obtained for execution and the sequence continues. On the other hand, if the instruction execution does correspond to the end of the strictly-bounded code block (test 708), then (assuming that the strictly-bounded code block implements an iterative construct) we check (709) to determine if the instruction is part of a last iteration thereof. If so, we exit (710), typically disabling the extended, altered or modified behavior that was previously enabled. If not, execution address and instruction/cycle counts are reset (711) as appropriate for the next iteration of the strictly-bounded code block. Note that, in embodiments where the strictly-bounded code block does not have an iterative character or (in the case of a temporally-specified execution point) is not employed within an iterative program construct, flows through steps 709 and 711 may be omitted and operation may proceed directing to exit 710.

### Other Embodiments

Although the invention is described herein with reference to specific embodiments, various modifications and changes can be made without departing from the scope of the present invention as set forth in the claims below. For example, while we have described techniques for establishing certain specific extended behavior (e.g., wait functionality) within a zero-overhead loop without squandering limited instruction positions available within the zero-overhead loop construct, our techniques have broader applicability. Alternative extended behaviors are contemplated and described herein. Applications to bounded blocks of program code and/or architectural constructs such as VLIW instruction packets and lightweight threads, procedures or tasks are contemplated and described as well.

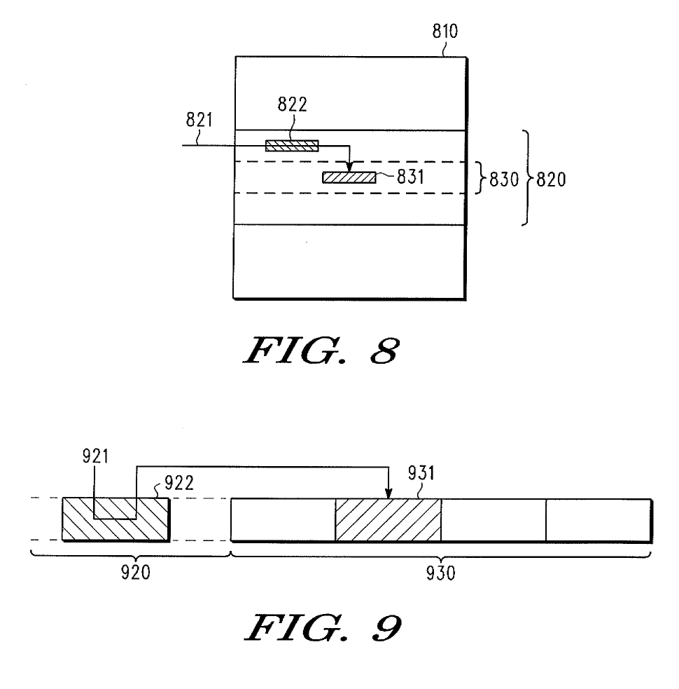

In this regard, FIG. 8 illustrates relations between a bounded block 830 of program code and a program construct (e.g., instruction(s) 822) that resides outside the bounded block but which is used to establish (821) a behavioral extension, alteration or modification operant at some point (e.g., at instruction 831) therewithin. In general, the elements shown in FIG. 8 may take on concrete form as a program code or module 820 instantiated (or instantiable) in computer readable storage 810.

Similarly, with regard to VLIW-type exploitations of the present invention, FIG. 9 illustrates relations between a VLIW instruction packet 930 and a program construct (e.g., instruction(s) 922 of one or more preceding instruction packets) distinct from VLIW instruction packet 930 but which is used to establish (921) a behavioral extension, alteration or modification operant at some point (e.g., at VLIW operation position 931) within VLIW instruction packet 930.

Embodiments of the present invention may be implemented using any of a variety of different information processing systems. Accordingly, while FIGS. 1 and 2, together with their accompanying description relate to exemplary general purpose and embedded processor-type information processing architectures, these exemplary architectures are merely illustrative. More particularly, although SOEMT-type processor designs (FIG. 3) and preempt/wait/resume operations (FIG. 4) provide a useful context in which to illustrate our techniques, processors without SOEMT characteristics and those that implement non-wait-type behavioral extensions are envisioned and described. Of course, architectural descriptions herein have been simplified for purposes of discussion and those skilled in the art will recognize that illustrated boundaries between logic blocks or components are merely illustrative and that alternative embodiments may merge logic blocks or circuit elements and/or impose an alternate decomposition of functionality upon various logic blocks or circuit elements.

Articles, system and apparati that implement the present invention are, for the most part, composed of electronic components, circuits and/or code (e.g., software, firmware and/or microcode) known to those skilled in the art and functionally described herein. Accordingly, component, circuit and code details are explained at a level of detail necessary for clarity, for concreteness and to facilitate an understanding and appreciation of the underlying concepts of the present invention. In some cases, a generalized description of features, structures, components or implementation techniques know in the art is used so as avoid obfuscation or distraction from the teachings of the present invention.

In general, the terms “program” and/or “program code” are used herein to describe a sequence or set of instructions designed for execution on a computer system. As such, such terms may include or encompass subroutines, functions, procedures, object methods, implementations of software methods, interfaces or objects, executable applications, applets, servlets, source, object or intermediate code, shared and/or dynamically loaded/linked libraries and/or other sequences or groups of instructions designed for execution on a computer system.

In some embodiments of the present invention, a computer program product is embodied in at least one computer readable medium and includes program code executable on a processor, wherein the program code includes a bounded block that is sufficiently compact to reside entirely within a fetch buffer or individual cache line of the processor. The program code encodes, using a program construct that appears outside the bounded block, a behavioral extension whose effect, upon execution of the program code on the processor, is limited to the bounded block and which coincides with a particular point in the execution of the bounded block. In some embodiments, the bounded block includes a zero-overhead loop, and the behavioral extension includes a wait operation that coincides with the particular point in the execution the zero-overhead loop.

All or some of the program code described herein, as well as any software implemented functionality of information processing systems described herein, may be accessed or received by elements of a information processing system, for example, from computer readable media or via other systems. In general, computer readable media may be permanently, removably or remotely coupled to an information processing system. Computer readable media may include, for example and without limitation, any number of the following: magnetic storage media including disk and tape storage media; optical storage media such as compact disk media (e.g., CD-ROM, CD-R, etc.) and digital video disk storage media, nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.; and media incident to data transmission including transmissions via computer networks, point-to-point telecommunication equipment, and carrier waves or signals, just to name a few.

Finally, the specification and figures are to be regarded in an illustrative rather than a restrictive sense, and consistent with the description herein, a broad range of variations, modifications and extensions are envisioned. Any benefits, advantages, or solutions to problems that are described herein with regard to specific embodiments are not intended to be construed as a critical, required, or essential feature or element of any or all the claims.

What is claimed is:

1. A method comprising:
establishing, for a particular execution context and using a program construct that appears outside a bounded block of program code, a behavioral extension whose effect is limited to the bounded block and which coincides with a particular point in the execution the bounded block,
wherein the behavioral extension codes a context switch but adds neither additional code space nor additional execution cycles to the bounded block.

2. The method of claim 1,
wherein the bounded block includes a zero-overhead loop, and
wherein the behavioral extension includes a wait operation that coincides with the particular point in the execution the bounded block.

3. The method of claim 1, further comprising:
executing the program code on a processor that implements a switch on event multithreading (SOEMT) programming model, wherein the context switch coded by the behavioral extension is from the particular execution context to a next-highest priority active context of the executing program code.

4. The method of claim 1,
wherein the program construct includes a wait offset instruction that precedes the bounded block in an execution sequence of the program code.

5. The method of claim 1, further comprising:
specifying the particular point using a positional indicator that identifies the particular point as coinciding with a particular instruction instance of the bounded block.

6. The method of claim 5, wherein the specifying includes loading a register with a value indicative of one of:
an instruction offset into the bounded block; and
a memory address.

7. The method of claim 1, further comprising:
specifying the particular point using a temporal indicator that identifies an execution cycle of the bounded block.

8. The method of claim 7, wherein the specifying includes loading a register with a value indicative of one of:
a cycle count; and
an instruction count.

9. The method of claim 1, wherein the bounded block is one of:
a low-overhead loop;
a lightweight procedure; and
a Very Long Instruction Word (VLIW) type instruction packet.

10. The method of claim 1,
wherein limited extent of the bounded block allows all instructions thereof to reside entirely within a fetch buffer or cache line of a processor on which the program code is to be executed.

11. The method of claim 1,
encoding the program code together with the program construct that establishes the behavioral extension in one or more computer readable media.

12. An apparatus comprising:
a processor including logic operable to establish a behavioral extension whose effect is limited to a bounded block of program code executing on the processor and which coincides with a particular point in the execution the bounded block, wherein the logic is triggered by execution on the processor of a program construct that appears outside the bounded block; and
a context controller responsive to the established behavioral extension.

13. The apparatus of claim 12,
wherein neither the program construct nor the behavioral extension consumes either additional code space or additional execution cycles in the bounded block.

14. The apparatus of claim 12,
wherein the processor implements switch on event multithreading (SOEMT);
wherein the bounded block includes a zero-overhead loop, and
wherein the behavioral extension includes a wait operation that coincides with the particular point in the execution the bounded block.

15. The apparatus of claim 12,
wherein the program construct includes a wait offset instruction that precedes the bounded block in an execution sequence of the program code; and
wherein the wait offset instruction specifies the particular point either positionally or temporally.

16. The apparatus of claim 12, further comprising:
a register whose contents are specified upon execution of the program construct that appears outside the bounded block; and
a comparator of the logic responsive to a value in the register that coincides with the particular point in the execution the bounded block.

17. A method comprising:
establishing, using a program construct that appears outside a bounded block of program code, a behavioral extension whose effect is limited to the bounded block and which coincides with a particular point in the execution the bounded block,
wherein extent of the bounded block is architecturally-, rather than programmatically-, defined and wherein the behavioral extension adds neither additional code space nor additional execution cycles to the bounded block.

18. The method of claim 17,
executing the program code on a processor that executes Very Long Instruction Word (VLIW) type instruction packets, wherein the architecturally-defined bounded block includes a VLIW type instruction packet.

19. The method of claim 17,
wherein the architecturally-defined bounded block is sufficiently compact to reside entirely within a fetch buffer or individual cache line.

20. The method of claim 17,
wherein the architecturally-defined bounded block is employed within a zero-overhead loop body.

21. The method of claim 17,
wherein the behavioral extension includes a wait operation that coincides with the particular point in the execution the architecturally-defined bounded block.

22. The method of claim 17,
wherein the program construct includes a wait offset instruction that precedes the architecturally-defined bounded block in an execution sequence of the program code.

23. The method of claim 17, further comprising:
specifying the particular point using one of:
a positional indicator that identifies the particular point as coinciding with a particular instruction instance of the architecturally-defined bounded block; and
a temporal indicator that identifies an execution cycle of the architecturally-defined bounded block.

24. The method of claim 17, wherein the behavioral extension includes one or more of:
a wait function not coded within the architecturally-defined bounded block;
an acknowledge function not coded within the architecturally-defined bounded block; and
a trace enable function not coded within the architecturally-defined bounded block.

25. The method of claim 17, further comprising:
executing the program code on a processor that implements a switch on event multithreading (SOEMT) programming model.
